(19) United States
(12) Patent Application Publication
(10) Pub. No.: US 2013/0073414 A1
(43) Pub. Date: Mar. 21, 2013

(54) CONSUMPTION ENGINE

(71) Applicant: Arthur E. Geldres, Melvindale, MI (US)

(72) Inventor: Arthur E. Geldres, Melvindale, MI (US)

(21) Appl. No.: 13/581,678

(22) PCT Filed: Mar. 4, 2011
(86) PCT No.: PCT/US2011/027152

§ 371 Date: Oct. 29, 2012

Related U.S. Application Data
(60) Provisional application No. 61/310,475, filed on Mar. 4, 2010.

(51) Int. Cl. G06Q 30/08

(52) U.S. Cl. 705/26.3

(57) ABSTRACT

One example method for facilitating a sale of a good or a service includes: receiving a selection of a geographic tier, the geographic tier defining a particular geography in which a seller is located; receiving a time period; receiving a bid from the seller for the sale of the good or the service within the time period; matching the bid with consumers whose offers meet requirements of the bid from the seller; when the bid results in maximum consumption of the good or the service, selecting the bid; and transfer money from the consumers to the seller.

This application is being filed as a National Stage Application of PCT International Patent application No. PCT/US2011/027152, filed 4 Mar. 2011 in the name of Arthur E. Geldres, citizen of the U.S., applicant for the designation of all countries, and claims priority to U.S. Provisional Patent Application Ser. No. 61/310,475, filed 4 Mar. 2010, the entirety of which is hereby incorporated by reference. To the extent appropriate, a claim of priority is made to each of the above disclosed applications.

### TECHNICAL FIELD

The present disclosure relates to commerce and e-commerce, which comprises electronic or any other type of energy upon which a communication network can be built, via a system that facilitates efficient consumption of any product or any service provided by merchant-entities to consumers in the traditional marketplace. This disclosure more specifically relates to an efficient system of novel marketplaces that protects consumers from monetary or financial risk for the purpose of strengthening them as a group—it is the humans in the aggregate that support any economy level—and the economy overall by providing them and weaker merchant entities protection from the threats existing in the traditional marketplace which effectively requires entity merchants to ignore all but their basic instinct to survive by exploiting uneducated or inexperienced or preoccupied consumers.

### BACKGROUND

Individual consumers have professional and personal responsibilities which limit their ability to consume efficiently, because removing all consumption risk requires knowledge or time individual consumers often lack. Merchants similarly endure risk in the traditional marketplace, such risk often related to competition from bigger or less geographically-concentrated entities or to a vast majority of merchants' inability to accurately quantify or gauge the number of customer relationships resulting from (online or offline) advertising costs incurred. Merchants with customers who use credit also endure additional revenue loss in the form of fees owed to creditors. These challenges compel some merchants to use pricing tactics or legal loop holes for each of their benefits to exploit busy or inexperienced or uneducated consumers.

Before electronic technology, individual consumers had more experience with and knowledge of the merchants (and their owners) from which they purchased goods or services such that they could trust in the consequences related to the ultimate destination of their money spent. As populations grew and technology progressed, however, both the average distance between merchants and an individual consumer and their overall dependence on creditors to facilitate their commercial transactions have substantially grown. With each transaction occurring more quickly and across greater distances, many busy or inexperienced or uneducated consumers often make purchase decisions based on price knowing little more than the retail merchant's brand name; the consumer often makes purchases having neither means to designate the geographic destination or the tax-revenue consequences of the time and money ultimately spent nor even the basic knowledge of such destination or consequences.

Equally important, the busy or inexperienced or uneducated consumer lacks any guarantee s/he paid a price equal to that paid by consumer who has more time, experience or education. This all occurs in a marketplace—the traditional marketplace—governed by rules written by politicians directly under the influence of merchant entities (typically larger, stronger, or less geographically-concentrated merchants such as, but not limited to, corporate conglomerates) so as to encourage massive and inefficient consumption by individual consumers. The price is rarely if ever uniformly charged to all consumers such that ascertaining the true value of a product or service consumed can be challenging or impossible. In light of this uncertainty, once can follow the monetary transactions related to any such consumption and find inequities related to such pricing between participants in the traditional marketplace.

The individual relationships in the traditional marketplace once aggregated can be represented by a triangle positioned upside-down, in which the two top spots on the left and the right represent merchant-entities aggregated and creditor-entities aggregated, and the bottom spot represents an aggregation of individual consumers—the group upon which the traditional marketplace relationship balances. With every act of consumption involving credit and communication technology, both the merchant and the consumer send money toward the creditor for facilitating the transaction. At least some merchants will pass part or all of the cost of this facilitation onto their consumers. The amount of money extracted from a consumer by a merchant is thus greater in today's traditional marketplace than in the one existing before the insertion of credit and communication technology into the traditional marketplace.

Consumers thus need a systematic means to not only increase the efficiency of their money and time spent but to also independently generate money for themselves. Consumers further need a means to use their money as effective speech in support or opposition of particular geographic regions or their related governments or sovereignties. Without an alternative marketplace to the traditional marketplace, it will continue to allow the systematic or inefficient depletion of the overall resources of the group comprised of individual consumers upon which the overall economy stands.

The Internet's impact on the way we live has been rapid and powerful. We can now communicate instantly and globally at all times. Communication can now be performed textually, graphically, with audio or video, and instantly at all times because of mobile communication technology. Although it has increased efficiency and convenience, the Internet has not yet profoundly changed the nature of how consumers purchase products or services and of how merchant entities compete to attract or to retain new customers. Despite having relatively new speed, convenience, knowledge and reach, individual consumers—the group upon which the economy's foundation rests—still lack sufficient time or resources to gain the knowledge and experience necessary to avoid pricing schemes in the traditional marketplace by merchants which feel pressure to compete or survive.

### SUMMARY

In one aspect, a method for facilitating a sale of a good or a service includes: receiving a selection of a geographic tier, the geographic tier defining a particular geography in which a seller is located; receiving a time period; receiving a bid from the seller for the sale of the good or the service within the time period; matching the bid with consumers whose offers meet requirements of the bid from the seller; when the bid results in maximum consumption of the good or the service, selecting the bid; and transferring money from the consumers to the seller.

In another aspect, a method for facilitating a sale of a good or a service includes: receiving a selection of a geographic tier, the geographic tier defining a particular geography in which a consumer is located; receiving a particular time period; receiving an offer including a price threshold for the good or the service; matching the offer to one or more bids to provide the good or the service; and when the offer meets requirements of a winning bid, notifying the consumer of a consummated transaction.

In yet another aspect, a method for facilitating a sale of a good or a service includes: receiving a selection of a geographic tier from a group including nation, state, county, and city; receiving a vote from the consumer for the good or the service to be offered for the geographic tier; receiving a particular time period; receiving branding requirements from the consumer for the good or the service; receiving an offer including a price threshold for the good or the service; matching the offer to one or more bids to provide the good or the service; and when the offer meets requirements of a winning bid, notifying the consumer of a consummated transaction.

### DESCRIPTION OF THE DRAWINGS

FIG. 1 shows an example system for facilitating the consumption of a good or service.

FIG. 2 shows an example of a geographic tier.

FIG. 3 shows an example method for a seller to provide a good or service for consumption.

FIG. 4 shows an example method for a consumer to consume a good or service.

FIG. 5 shows an example method for matching bids with a good or service.

FIG. 6 shows an example method for voting for a good or service for consumption.

FIG. 7 shows an example method for implementing a lottery.

### DETAILED DESCRIPTION

The example systems and methods described herein provide a more efficient alternative to the traditional marketplace. In some examples, the embodiments described herein can simultaneously remove the risks encountered by all human consumers in the traditional marketplace and reduce the risk encountered by smaller or more-geographically-concentrated merchant-entities in the traditional marketplace by providing all merchant-entity participants 1) protection from bigger or less geographically-concentrated entities, and 2) an improved marketing and/or sales efficiency using group sales (and equal pricing) in a repeatable-conversion of blind associations. Associations can be based on a common interest in a type of product or service where disclosure of relevant purchasing and sales criteria information occurs between parties participating, except for any disclosure of particular terms material to a consumption contract, such as but not limited to individual price points and names/brands of any of the participants, whether the participants be an entity or a human. In the disclosed examples, transactions are consummated within a consumer-creditors-merchant interaction, to ultimately establish on-going individual consumer-merchant relationships within the system, with consequential feedback available by, to and between both parties to the relationship in the aftermath of any interaction caused by the system matching one or more merchant-entities with one or more individual human consumers.

To match participants, the system provides competitive situations for merchant participants independent from those provided for consumer participants, however both types of situations—within a particular geographically-defined novel marketplace of the many available within the system—relate to a particular product or service, the selection of which is based on the preferences, established via a voting system, of participants in the particular geographically-defined novel marketplace.

The competitive situations of any repeatable conversion within any geographically-defined marketplace selected: 1) by a participating consumer within the system may require him/her to also designate most of his/her individual purchasing preferences or criteria, including a maximum price threshold and financial authorization for such a threshold but excluding any particular merchant-entity's name preferred as a seller or retailer of a brand (unless the seller is the original source manufacturer of a particular brand, in which case an individual consumer may indicate a preference for that merchant-entity seller by indicating the brand as a purchase preference in his/her purchasing criteria) within a product category or service category or of a product or service (“product or service” also means “product category or service category”) previously designated via the voting system further disclosed later; and 2) by a participating merchant within the system require it to designate at least a price-point preference or threshold (some embodiments may be utilized as industry specific such that brand selection may not be necessary) and sometimes also a brand or quantity (finite or infinite) preference or threshold based on its individual business model, inventory, marketing costs and/or strategy, and/or on consumer-participants' demand data disclosed by the system that excludes at least the individual names and individual “price thresholds” (other embodiments allow for the matching of consumers with service providers, such as those providing credit, in which case the undisclosed “price preferences or thresholds” may equate to some other element of a sales or purchasing criteria specific to the related industry of the service provider; consumption of services such as insurance or credit in the traditional marketplace often rely on rating systems and other criteria unknown to or not understood by the vast majority of consumers) of the participating individual consumers for the same product or service previously designated via the voting system; all in a design to achieve a simultaneous processing of selection-outcomes by matching merchants and groups of individual consumers based on scenarios calculated for maximum consumption (the best price preference or threshold bid by a participant does not alone necessarily correlate with maximum consumption) within each geographically-defined novel marketplace.

Using the purchasing and sales preferences of consumers and merchants the system in this example can match for consumption: (a) an individual merchant with either one group of consumers for one brand of a particular measure of a product or service (previously established by voting), or with multiple groups of consumers, each group in this example differing in brand-preference only of a particular measure (not all brands are manufactured in exactly the same units of measure, so nominal differences in measures of a product or service may occur between brands in any given run-through of the repeatable conversion) of a product or service (previously established by voting); and/or (b) an individual consumer with either one individual merchant for one brand of a particular measure of a particular product or service (previously established by voting), or with one or multiple merchants for multiple or different brands of the particular measure of the product or service (previously established by voting). No two individual consumers, in this example, competing within the same repeatable conversion of the same geographically-defined, -recognized, and -selected novel marketplace and for a same brand and measure of a product or service in the system pay a different purchase price than the other for the product or service (previously established by voting).

The system has many embodiments. Although one disclosed embodiment relates to goods and services generally, other embodiments of the system may be utilized commercially for specific industries comprising goods (including but not limited to cash cards or gift cards or any equivalents) or services (including but not limited to cash cards or gift cards or any equivalents) related but not limited to: clothing and apparel; sports and sporting endeavors; gas (gas is somewhat unique in that consumption of fuel via a pre-paid cash or gift card or equivalent having commercial value may be measured out for bidding by and within the system using a metric of the product, such as gallons (used in the traditional marketplace for fuel purchases or sales), rather than by a metric of the consideration or money, such as cash or its equivalent, typically exchanged for such a card in the traditional marketplace; the individual consumer participating in the system would bid a price preference or threshold for a measure of fuel credited to a card (such as but not limited to: 10 gallons of fuel, 50 gallons of fuel, 100 gallons of fuel, 200 gallons of fuel or 300 gallons of fuel) provided for consumption by a merchant-entity (perhaps needing instant revenue or wanting such one or more consumers' long-term business or having some unique motivation) participating in the same repeatable conversion in the same geographically-defined novel marketplace as the bidding consumer) or energy; television/intern& equipment or services; electronics or technology; furniture or households; meat or produce or food ;restaurants; pharmaceuticals; hotels or resorts; vacation packages; casino products and services; massage and other therapy and healing; tattoos; rental property or services; communication technology such but not limited to phones; education or instruction or tutoring; care giving such as but not limited to child or pet care; transportation; acting and/or cinema/theater; books or media or entertainment; events such as but not limited to those showcasing art or sport; elective surgery; professional services (with all or most of the rules governing professional conduct still applicable to a consumer-merchant relationship established with the system); or other services or products such as those related to insurance or credit/lending (the purchasing and sales criteria for any repeatable-conversion provided to system participants to designate their preferences would implement, implicate or use ratings, scores or other quantifiable data about consumers typically used by such service providers in the traditional marketplace). Many services may be consumed within the system by a temporal metric such as but not limited to an hourly or daily metric; money paid for time ultimately not used or returned to the merchant-entity may be refundable in some examples.

Although one embodiment creates relationships between human consumers and merchant entities, other embodiments of the system may be utilized commercially to match entities with entities rather than matching entities solely with human consumers; some examples of entities that may be matched within and by the system comprise manufacturers, wholesalers, distributors, retailers or creditors such that they may be inserted into the role of the human consumers to benefit in part by participating risk free, or into the role of a merchant-entity to benefit in part by participating at a quantifiable and calculable—and thus foreseeable—cost (also known as a “controllable-variable” cost) only when it actually wins a particular competition within a repeatable-conversion of a particular geographically-defined novel marketplace in the system as described in this embodiment. In this example, the system defines its fees for a winning merchant-entity as “controllable-variable” because the fees may vary based on the voluntary commitment and/or performance of the merchant-entity registered in the system. The fees are: 1) a transaction fee equal to either a percentage of revenue generated by or resulting from any competition involving a winning merchant-participant under a contract obligating it to one level of commitment or participation to the system or its administrator, or a greater percentage of such revenue generated by or resulting from any competition involving a winning merchant-participant under a contract obligating it to a lower level of commitment or participation to the system or its administrator; and 2) a penalty fee incurred by a winning merchant-entity based on its previous performance within the system which can equate to a monetary cost or charge, no cost or charge, or even a negative charge (i.e. a reward or monetary credit) consistent with a mathematical quantification of its performance within a range of good and bad established by the system or in any contract related to the system and a merchant-entity participating in it.

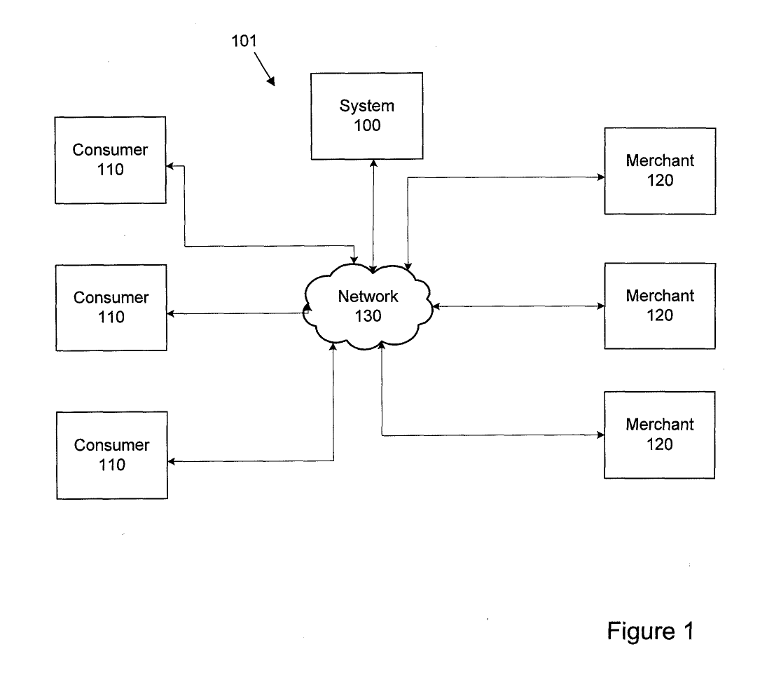

Referring now to FIG. 1, the following generally describes one embodiment of the system 100.

Geography—The system 100, using registration process and data, generally categorizes individual human consumers 110 and merchant entities 120 by their consumption or income-related activity within a particular geographic region in the traditional marketplace that logically relates to a tax structure implemented by a government or sovereignty representative of the geographic region.

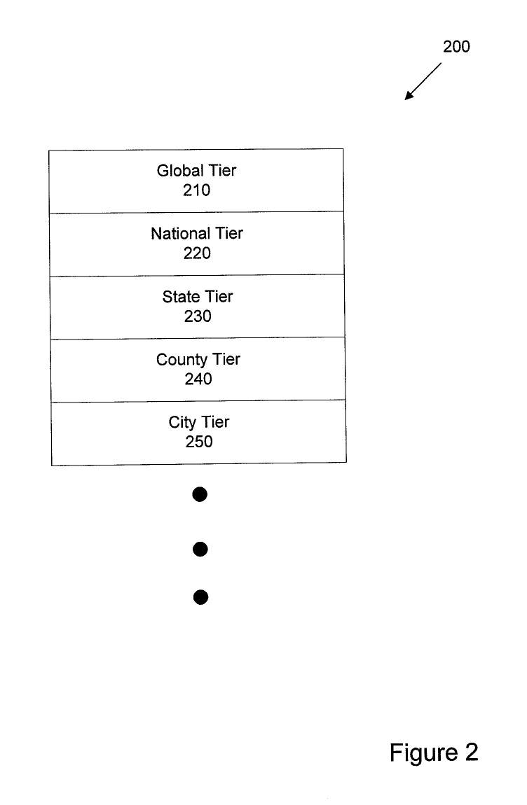

As shown in FIG. 2, the system 100 thus systematically provides any and all human consumers a hierarchical scheme 200 to consciously designate, via consumption within the system, the destination of their resources to the tax base of the government or sovereignty and related or corresponding economy geographically defined by the novel marketplace selected by him or her in a given marketplace-tier within the system. Using the United States of America as a context for an ongoing-example to which to apply this embodiment, one marketplace-tier would be a global tier 210 followed more narrowly next by a national tier 220 and then more narrowly by a state-tier 230 and then more narrowly by a county-tier 240 and then more narrowly by a city-tier 250 and so on and so forth such that a merchant-entity participating in the system is restricted by it: the entity may at a maximum register for—and thus enter and compete within—only one novel marketplace for each one of the marketplace-tiers available to it.

In this example, any merchant-entity 120 properly registered with the system may thereafter enter and compete in the global marketplace-tier 210 (which, as the broadest of tiers in this embodiment, currently consists of only one novel marketplace because no life is known on other planets with which or whom to establish commercial relations), but only sufficiently American merchant-entities (defined as those with a required percentage of their employees and/or managers working and/or residing in the United States of America) may enter and compete in a novel marketplace labeled “United States of America” existing within the narrower national marketplace-tier 220 in the system; a merchant-entity is required to first achieve eligibility—based on how it is recognized geographically by its government or its law or by other governments and their laws or by the system or its administrators—to enter a particular novel marketplace (here the United States of America marketplace) and its related tier (here the national marketplace-tier 220) before the entity may compete in the marketplace or its related tier, within in the system. Similarly, a merchant-entity based in and/or paying its taxes to the United States of America may not enter the novel marketplace labeled “Peru” in the national marketplace-tier, because the entity, though it meets the eligibility criteria to enter the national tier, does not meet the stricter eligibility requirements established within the system to enter Peru's particular novel marketplace in the national marketplace-tier.

In this ongoing example, an American company and a Peruvian company can compete within the system only in marketplace-tier more broadly defined by geography than the national marketplace-tier. Further, just as each country on earth represents within the system a discreet novel marketplace in the national marketplace-tier, so does each state represent a novel marketplace in the state marketplace-tier (or regional marketplace-tier if the relevant country has regions rather than states) which consists of a discreet or particular novel marketplace for each of the fifty states (and/or for each of their equivalent regions as related to other countries) recognized by and/or established within the system.

In contrast, the system 100 generally allows any participating individual (human) consumer 110, properly registered, to enter any geographic marketplace in any tier within the system (it generally limits, however, every participating individual merchant-entity to one discreet or particular novel marketplace within a geographically defined marketplace-tier). In this way, the system allows a consumer to choose any of its marketplaces with a clear expectation or understanding of where a merchant (with which s/he may be matched by the system for consumption) in a novel marketplace conducts business and/or employs humans and of what sovereignty or government the merchant-entities eligible to compete in the chosen novel marketplace likely pay their taxes to.

The system 100 also protects smaller or more-geographically concentrated merchant-entities 120 from larger or less-geographically concentrated merchant-entities—the latter generally being stronger and less vulnerable in the traditional marketplace than the former—unless the former chooses to enter a broader marketplace-tier that exposes it to competition from the latter. For example, a company, based entirely in the state of Michigan, competing in the system's state tier 230 would have protection from another company based throughout (i.e. having employees, managers, staff or other personnel in more than one state even if one of the states is MI) the United States of America and ineligible consequently to enter either the state tier 230 or the Michigan marketplace within that tier 230, unless the former (smaller MI) company chooses to enter a broader marketplace-tier such as national tier 220 wherein the latter other company may have eligibility to compete.

Furthermore a merchant-entity with, for example, all of its personnel residing in and/or working in and/or paying taxes to the state of Minnesota, for example, may have eligibility to compete in the state-tier (via the MN marketplace) but may nonetheless not enter the MI marketplace in that same state-tier because it lacks eligibility (i.e. sufficient connections or contacts with the state of MI) to enter Michigan's particular marketplace for the state tier. Generally a company eligible to compete in a marketplace for a given tier has eligibility to compete in at least one marketplace of a broader tier, but a company eligible to compete in a tier may sometimes not have eligibility in even one marketplace in a narrower tier; The tax-related demographics or geographic distribution of a merchant-entity's personnel determines the tier and marketplace eligibilities of the entity. In this example, the global tier, being the broadest marketplace-tier, provides only one novel marketplace—the world's or earth's marketplace—where an American company can compete with a Peruvian company.

In a similar way, the system 100 may use the zip codes of individual human consumers 110 obtained during their registration (a) to determine the geographic distribution of its registered consumers and to disclose organized but filtered (retaining in one example of the system at least individual price thresholds and identities of consumers) data such as, but not limited to, that related to (1) consumer demand (which the system of this example receives in the form of prepayment of funds (i) by consumers and (ii) in relationship to measures or units of a metric of a product/good or service authorized for purchase) and (2) the geographic relationship between individual consumer residences and a relevant marketplace-tier or -geography of a given repeatable conversion competition of the system and (b) to ultimately aid the participating merchant-entities within a particular geographically-defined novel marketplace with their system-participation-business decisions related, at least in part, to their bids (price, quantity, etc.) for the consumer demand related to a competition (of possibly multiple or many competitions in a repeatable conversion) between eligible merchant-entities in a repeatable conversion of the novel geographic marketplace.

The data disclosed may in one example comprise data from a marketplace-tier that distinguishes between authorized consumer demand (authorized here means purchasing demand payable as up-front revenue to a winning merchant conditioned upon its promise via bid to satisfy binding purchasing preferences (i) inputted by the winning individual consumer-users and (ii) disclosed materially by the system to the competing merchant-entities) generated outside a particular geographically-defined novel marketplace in the tier and authorized consumer demand generated within the geographic marketplace to allow merchant-entities a means of assessing the potential growth of their relationships in the marketplace-tier and of analyzing or assessing strategy for a possible entry into or departure from different—whether more or less-broadly defined by geography—marketplace-tiers and/or their geographic markets in the system or for maintaining a status quo of system participation.

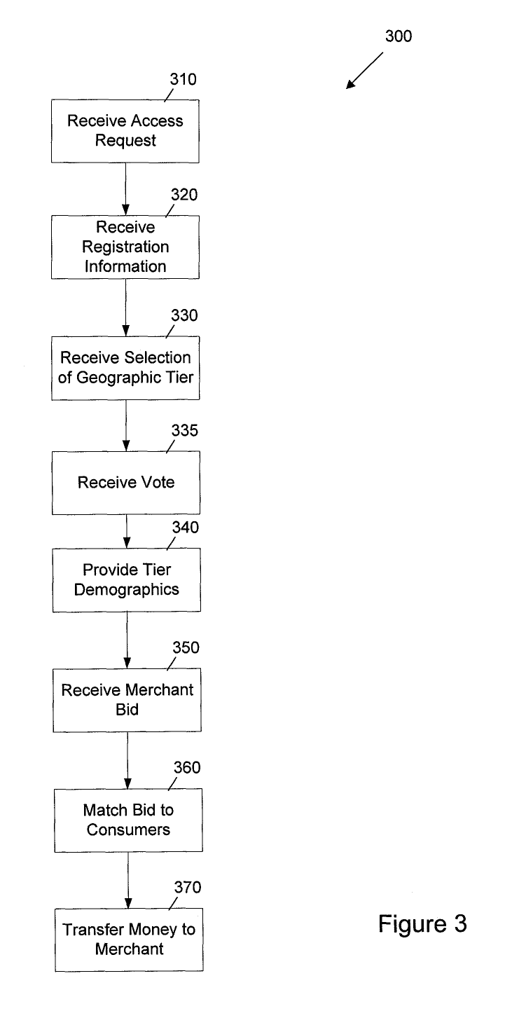

Referring now to FIG. 3, in this example, every participant 110, 120 registers with the system 100 using an example method 300. Initially, the participant accesses the system in operation 310. At operation 320, the participant registers by providing sufficient information to uniquely identify the participant. In addition, the system requires each agent registering an entity on behalf of that entity as a participant within the system to register himself/herself also as an individual human-consumer-participant in order to further ensure the integrity of the geographic categorization or distinctions of the particular participants within the system; in other words, every human is a consumer, and because a human registers an entity, that human also registers him/her-self as a participating human-consumer when s/he registers the entity in order for the system to at least track, maintain and/or protect the integrity of its overall-system functionality and to avoid and prevent manipulation of the integrity of the value created, established or exchanged within the system or any of its geographically-defined novel marketplaces or their respective marketplace-tiers.

At operation 330, the entity selects a relevant geographic tier. In this example, each merchant-entity participant 120 can only enter or compete in one geographic marketplace within a given marketplace-tier in the system; for example, a merchant-entity having one location in MI may only enter the “MI marketplace” in the system's marketplace-tier comprising the fifty United States of America and cannot enter (and thus switch over into) another geographic marketplace (“MN marketplace” for example) in that tier without changing the facts of its business to meet the tax-related eligibility-requirements for the desired geographic marketplace in the same marketplace-tier. If the MI merchant-entity wanted to compete against merchant-entities in other states or in other regions without changing the facts of its business, it may enter a broader national marketplace-tier comprising the “United States of America” geographic marketplace in the system but may not enter another country's geographic marketplace in the national tier without changing the facts of its business to meet the tax-related eligibility requirements of the desired country's geographically-defined novel marketplace.

A merchant entity's eligibility to enter a geographically-defined novel marketplace relates to the percentage of its managerial employees or of its ownership or of its personnel overall who pay taxes to the geographic region's government or sovereignty; for example, in the “national-tier,” a merchant entity could not enter the United States of America marketplace without first meeting the system's eligibility requirements having a basis on the entity's percentage of owners, managerial staff, and/or personnel overall paying taxes to the federal government of the United States of America. Each entity-participant is therefore required to provide a billing address and/or a shipping address and/or a registered address that matches its geographic-system designation used to regulate geographic marketplace access within the system along with sufficient disclosure of the tax-revenue obligations owed by its personnel and the related governments or sovereignties. Each human-participant is required to provide information indicating and proving his/her geographic residence and/or billing address consistent with her/his personal credit.

Equal Pricing—The example system 100 creates equal pricing in any one of its geographically-defined novel marketplaces by capturing groups of individually authorized purchases in such a geographic marketplace along with their corresponding individual purchasing preferences from individual consumers for a particular product or service previously selected (through a voting system further disclosed later). The system presents to eligible merchant-entities 120 of the geographic marketplace an opportunity to win up-front or instant revenue via a number of units authorized for purchase shown by the system as demand data in the context of a bidding competition (as part of a repeatable-conversion further disclosed later) between merchant entities that in part entails the system's disclosure of a range of (rather than any isolated or actual) individual purchase-price thresholds authorized by participating consumers for each unit of a brand of the particular product or service featured by the system for that particular geographic marketplace (in other examples a consumer's bid does not relate to a brand but still does relate to a price preference or threshold and a number preference of the units of the product or service); in this way each eligible merchant-entity is aware of the range of price-points related to the disclosed demand so that it may bid a price that can fall within that range for the purpose or objective of winning a competition of a repeatable conversion within the particular geographically-defined novel marketplace.

Within any given competition, the system 100 further discloses, at operation 340, the total number of units of each brand of the product or service authorized for purchase in a competition or repeatable conversion or geographic marketplace. In light of consumers' ability to enter any geographic marketplace in the system, the demand data disclosed in a competition, conversion or marketplace may also distinguish—for an eligible and participating merchant-entity's possible scrutiny—between two or more purchase authorizations by the authorizing consumers' various and discrete geographic locations registered into the system. It may in other examples disclose statistical demand data or analyses such as but not limited to statistical distributions of demand data captured by the system.

Using this data, any eligible merchant-entity of a novel-marketplace can determine a range of cost associated with supplying a featured brand of a product or service previously selected at a sales price it bids based on that price-point, the total number of units authorized for purchase for a particular brand and measure of a product or service previously selected, and its known percentage fees owed to the system if it wins; if a participating merchant-entity submits a losing bid, then it pays the system nothing (a consumer in contrast never pays a penny to engage, use or utilize the system). In other examples of the system, a merchant-entity that bids a preferred sales price must also bid a quantity (a finite or infinite number; limited or unlimited supply) of units of the service or product offered for sale or promised to winning consumers at the price bid; in this example a merchant-entity may participate with full knowledge of any monetary risk that stems from it winning a competition of a repeatable conversion in a geographic marketplace.

By submitting at operation 350, via a merchant-bid in a competition, a price and/or a brand and/or a quantity of units (of a product or service or of a brand of a product or service previously selected for feature or consumption within the system) preferred or promised by a merchant-entity in relation to a featured or systematically consumable measure of a product or service, the merchant-entity commits to providing a brand of product or service at a uniform and equal price point to either (i) a number of consumers who in the aggregate or individually first (a temporal designation or marker in some examples may be placed on each bid by a consumer) committed to purchasing a number of units equal to or less than the quantity promised or preferred by the winning merchant-entity; or (ii) each and any and every individual consumer who's bid authorized in the relevant geographic marketplace at least the winning merchant-bid's price-point while matching his/her purchasing preferences with the winning merchant-bid's brand, measure, color, etc. of a product or service. The winning bids (defined by those of one or more consumers matched with those of one or more merchant-entities) of participants are those that when matched (merchant bids matching with consumer bids) result in maximum consumption of the featured or systematically consumable brand of the product or service of the geographic novel marketplace at operation 360. A winning merchant-entity that fails to sufficiently deliver the total number of units promised or preferred by it (the total number of units related to maximum consumption is either (i) the quantity of units promised or preferred by the winning entity, or (ii) the number of units authorized for purchase by the individual consumers using but not limited to purchase-price thresholds, brand selection, and/or quantity selection) of a particular measure of a product or service featured by or consumable in the system at the price point bid or otherwise fails to deliver the product or service promised to the individual consumers under the terms agreed upon within the system, its rules or with its administrators can suffer from increased penalty fees based on those consumers' feedback. In other examples of the system repeated failures or any single egregious failure by a merchant-entity may also lead to further penalties or financial consequences related to the entity's existence and/or participation within the system.

Using data disclosed for a competition or repeatable conversion, any eligible merchant-entity of a related marketplace can similarly determine a range of benefit or a specific quantifiable benefit associated with supplying a featured or systematically consumable product or service at a preferred or promised sales price based on, but not limited to, for example: the number of units authorized for purchase and connected to consumers from outside the particular geographically-defined marketplace, the entity's traditional-marketplace marketing budget/strategy/expenses (sometimes associated with money spent relative to consumer relationships formed or enhanced or maintained), its inventory analysis, its debt/assets analysis and its other unique requirements.

Further, the system in this example does not disclose any individual price-point bid or designated as a threshold by any participant—entity or human—until after a repeatable-conversion or at least one of its competitions is successfully attempted which occurs when the timing mechanisms or requirements—designed into the system's regulation of bidding for each conversion or one of its competitions in a geographic marketplace—align for the purpose of processing or determining or creating winning/binding bids or maximum consumption between merchants and consumers; the system discloses (i) the process or creation or determination results of winning bids or maximum consumption simultaneously to, at least, the winning participants, and/or (ii) results-data from conversions or competitions completed that produced winning bids or maximum consumption. In other examples of the system, it discloses results-data even if a conversion or competition does not produce winning bids or maximum consumption.

Simultaneous-Selection-Outcome Processing/Matching—At operation 360, the system 100 attempts to establish, at the end of each repeatable-conversion or competition therein, a simultaneous processing or matching of bids to determine the selection of bids that creates efficient consumption outcomes when matched together; this embodiment attempts to create efficient consumption by processing for maximum consumption between a merchant-entity 120 and a group of individual consumers 110. After sufficient processing/matching at operation 360, the system at operation 370 exchanges (i) winning group-of-consumer's authorized money or its equivalent, in the form of instant revenue/funds, with or for (ii) a winning merchant's simultaneous promise to supply a particular measure of a brand of a product or service (meeting the preferences set by all the winning participants) to each individual consumer of the winning group at the price preference bid by the merchant. The repeatable-conversions used by the system in each geographically-defined novel-marketplace further comprise (i) one or more competitions among individual consumers for one or more of the products or services featured or systematically consumable, and/or one or more of the particular brands of a product or service featured or systematically consumable, and/or one or more of the particular measures of a product or service featured or systematically consumable and (ii) one or more competitions among individual merchants for one or more of the products or services featured or systematically consumable, and/or one or more of the particular brands of a product or service featured or systematically consumable, and/or one or more of the particular measures of a product or service featured or systematically consumable as follows.

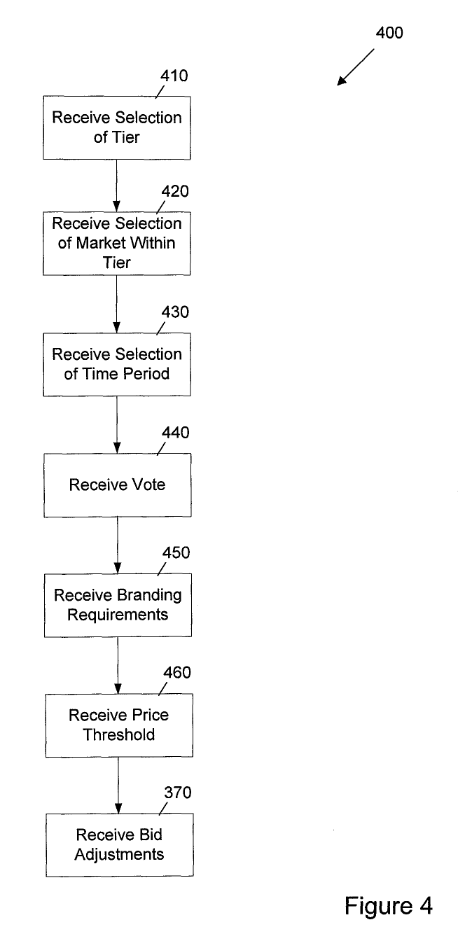

Consumer Competition—Referring to FIG. 4, after an individual consumer 110 has given a birthday, zip code, credit card, and/or other information required for proper registration, s/he may participate in a method 400 by engaging or using the system 100, via a network 130, such as the Internet, or other advanced communication network that supports instantaneous interaction and/or interfaces—while stationary or mobile—and first selecting a geographically-defined marketplace-tier to enter at operation 410.

The participating consumer next, at operation 420, selects a geographically-defined novel marketplace within the marketplace-tier scheme 200 previously selected by him/her.

S/he, at operation 430, selects a time period of interest from an interactive calendar representing time, from the past or present or future, organized or categorized in conjunction with systematic commercial activity that occurred, is occurring or will occur in the marketplace chosen at operation 420. S/he may also select a year other than the current year by scrolling to years in the past or future or by using any other means of time selection in the prior art; the interface page for the current or selected year may have its 52 weeks listed in correlation to the product or service established via voting for and, in-part, by the participation and/or consumption by and/or between merchants and/or consumers eligible to participate in a relevant geographic marketplace. If a participating consumer chooses a past week, the system provides him/her data related to conversions or competitions in the relevant marketplace and a ratings system (further disclosed later) related to the repeatable-conversions or to one of their competitions that occurred during the week chosen. In some examples of the system a calendar/temporal interface also displays a voting status (further disclosed later) and/or a lottery status (further disclosed later) of the participant, and each status is determined using results from previous participation within the relevant geographic marketplace.

The embodiment of the system uses a voting sub-system (further disclosed later) to establish the product or service for repeatable conversions for a past, current, and/or future week such that if a participating consumer 110 chooses a future week, the system may feature or showcase to her/him a product or service selected for possible consumption via voting and may provide an opportunity, at operation 440, to vote for the measures and/or brands and/or other characteristics/traits of the product or service for the week chosen; sometimes the future week selected in a particular marketplace may not have a related product or service established/featured/showcased such that the system alternatively provides a participating consumer (i) a voting opportunity for the selection/determination of a product or service or (ii) an adequate disclosure of the opportunity to vote for a product or service or for other characteristics of a product or service previously established.

If, however, a participating consumer selects within a particular geographical marketplace a current week—which relates to a product or service (and all other characteristics of the product or service necessary for consumption within the system) already designated by the system—s/he has opted to possibly engage in at least one competition of a repeatable-conversion to consume a designated measure (each day of a week in this example features a different measure of a product or service previously established by voting) of the product or service in the geographic marketplace. Although the system by default may provide a participating consumer a competition related to a measure of the product or service designated for the current day, s/he may alternatively or additionally opt to select within the relevant week a different day—and hence a different measure—of the same featured/established product or service.

In other embodiments, color or some other purchasing preference or criteria (specific industries of commerce such as but not limited to those related to insurance or credit often rely on scores and/or ratings in a manner undisclosed to the public which make difficult ascertaining all or various metrics, measures or measurements by which to vary a product or service in a geographic marketplace of the system) can serve as a measure of a product or service such that the measure varies daily in the geographic novel marketplace. The system in some examples may not be able to feature on a given day measures or measurements exactly and uniformly equivalent to each other across all brands (which don't each always utilize the same measures or measurements for their products or services) featured on the day in a particular competition of a repeatable conversion in a relevant geographic marketplace; the system therefore may provide metric or measured equivalents for each brand featured on the day so consumers can compare measurements and/or pricing across all brands featured in a repeatable conversion in the relevant marketplace.

After a participating consumer has selected a measure of a featured or previously established product or service, s/he designates whether or not s/he has indifference about one or more brands (of the product or service) featured or available for consumption relative to his/her other purchasing criteria or preferences at operation 450. If the participating consumer has brand-indifference, s/he sets a price-threshold (price-threshold as a binding purchasing preference or criteria in this example may, in other examples, correlate to some a different material term of consumption such as but not limited to: interest rate, principal amount, term or time-related factors, BMI or other health-related indices or metrics, driving record or related scores or quantified data of personal automotive history, credit score or other credit-related indices or metrics related to credit history), as a binding purchasing preference, for each and every brand featured or established for consumption by the system in a relevant geographic marketplace for the measure selected at operation 460.

If the participating consumer does not have brand-indifference, then s/he does not have to set for each and every brand featured by the system a price-threshold at operation 460 and also should not set a price threshold for any brand which s/he does not want to consume; in another embodiment, the participating consumer can rank brands of a product or service s/he desires of those featured by the system before, after or while s/he sets a price-threshold for the brands desired such that the system factors a ranking into a determination of the bids that when matched create efficient or maximum consumption in the relevant competition, conversion or geographic marketplace.

The participating consumer in this example may further designate purchasing preferences related but not limited to color, quantity-per-brand, and total-overall-quantity.

To place a winning bid for a product or service in a competition of a repeatable-conversion in a geographic marketplace in the system, a participating consumer authorizes, via cash, a hold charge or some equivalent, a purchase of one or more units of a measure of the product or service consistent with his/her purchase preferences such that when coupled with a blind bid (in which the bidder does not know the individual price preference or threshold of a participant with whom or which the bidder may be matched) of a merchant (i) results in consumption at a winning merchant's price preference which may not exceed a price-threshold designated by any winning consumer and (ii) also creates maximum consumption within a repeatable conversion of the marketplace of a brand featured for the measure featured; each unit of a product or service, having a previously established or selected measure, authorized for purchase by a consumer in a repeatable conversion of a marketplace may still vary by brand, rank, price threshold or preference, color and/or other traits/characteristics (in other embodiments, color rather than measure may be previously established by voting for each day in a novel-marketplace consequently leaving other traits/characteristics of the product or service available for the determination of binding purchasing preferences) such that the consumer has created variation in his/her conditional preferences related to his/her potential purchase via bidding. S/he may adjust her bids at operation 370 for any single unit at any time beginning with an unveiling by the system of the measure of a product or service featured for a particular marketplace and ending with the system's deadline for altering bids for the particular measure in the relevant geographic marketplace. After such a deadline, the consumer has bound her/him-self to his/her binding purchase-bid (conditioned on satisfaction of the preferences in the bid) until the repeatable-conversion concludes with a disclosure, by the system of any winning bids to relevant participants, that follows a simultaneous processing for maximum or efficient consumption relative to the competitions in the repeatable conversion.

For each brand the system 100 features of a (measure previously established of a) product or service subject to potential consumption via a geographic marketplace, the system also displays daily in the system's geographic marketplace the related traditional price—as advertised to an individual consumer in the traditional marketplace—of the product or service for participating consumers' information or knowledge or comparison relative to setting their own price—thresholds or—preferences for the product or service (individual price-preferences or thresholds by any participant do not get disclosed by the system to its participants or to the public until after the related repeatable conversion reaches completion). The system also discloses any applicable or relevant marketplace or conversion deadlines (in other examples each repeatable conversion for a previously established measure of a product or service in a geographic marketplace may contain a running clock to aid in designating the moment or moments in which a participant's bid or bids are binding or are no longer or not subject to change).

Merchant Competition—Referring again to FIG. 3, after an individual merchant 120 has properly registered (see operation 320), the merchant may participate by engaging or using the system, via the network 130 (e.g., Internet or other advanced communication network that supports instantaneous interactions and/or interfaces while stationary or mobile) and first selecting a geographically-defined marketplace-tier to enter (see operation 330); as stated previously a merchant in this example must also have eligibility to enter the marketplace-tier selected. In other examples the merchant may alternatively first select a geographical marketplace (which relates to a tier such that selection of a marketplace implicitly or contemporaneously selects a tier) to enter.

In some examples, the participating merchant 120 next selects a time period of interest from an interactive calendar representing time, from the past or present or future, organized or categorized in conjunction with systematic commercial activity that occurred, is occurring or will occur in a marketplace or tier chosen at operation 330. As with the temporal/calendar interface (discussed previously) provided by the system to an individual consumer, a merchant may also select a year other than the current year by scrolling to years in the past or future or by using any other means of time-selection in the prior art; the interface page for the current or selected year may have its 52 weeks listed in correlation to the product or service established via voting for and, in-part, by the participation and/or consumption by and/or between merchants and/or consumers eligible to participate in a relevant geographic marketplace.

If a participating merchant chooses a past week, the system provides it data related to conversions or competitions in the relevant marketplace and a ratings system (further disclosed later) related to the repeatable-conversions or to one of their competitions that occurred during the week chosen. In some examples of the system a calendar/temporal interface also displays a voting status (further disclosed later) and/or a lottery status (further disclosed later) of the participant-user, and each status is determined using results from previous participation within the relevant geographic marketplace.

The embodiment of the system uses a voting sub-system (further disclosed later) to establish the product or service for repeatable conversions for a past, current, and/or future week such that if a participating merchant 120 chooses a future week, the system may feature or showcase to the entity a product or service selected for possible consumption via voting and may provide an opportunity, at operation 335, to vote for the measures and/or brands and/or other characteristics/traits of the product or service for the week chosen; sometimes the future week selected in a particular marketplace may not have a related product or service established/featured/showcased such that the system alternatively provides a participating merchant (i) a voting opportunity for the selection/determination of a product or service or (ii) an adequate disclosure of the opportunity to vote for a product or service or for other characteristics of a product or service previously established.

If, however, a participating merchant selects within a particular geographical marketplace a current week—which relates to a product or service (and all other characteristics of the product or service necessary for consumption within the system) already designated by the system—the entity has opted to possibly engage in at least one competition of a repeatable conversion to supply a designated measure (each day of a week in this example features a different measure of a product or service previously established by voting) of the product or service in the geographic marketplace. Although the system by default may provide a participating merchant a competition related to a measure of the product or service designated for the current day, s/he may alternatively or additionally opt to select within the relevant week a different day—and hence a different measure—of the same featured/established product or service.

After the participating merchant has selected a measure of—and hence a day of the week for—a product or service featured, the system discloses demand data for various featured brands of that measure that does not include the individual price-point thresholds of the bids of consumer participants; a participating merchant submits a bid (see operation 350) that comprises (but is not limited to): brand selection (from those featured by the system in a relevant repeatable conversion of a relevant geographic marketplace), price-point (thresholds or preferences here may equate in other embodiments to alternative terms related specifically or exclusively to consumption in various industries such as but not limited to the insurance or credit industry) preference, shipping rates (for the type of product or service to destinations consistent with at least the marketplace-tier selected), and/or various warranty offers that remains valid for a reasonable time after receipt.

The system in some examples may not be able to feature for a given day measures or measurements exactly and uniformly equivalent to each other across all brands (because a brand rarely runs in the same measurements as one, two, or three or more other brands for the same type or kind of product or service) featured on the day in a particular competition of a repeatable conversion in a relevant geographic marketplace; the system therefore may provide metric or measured equivalents for each brand featured on the day so merchants can (i) compare measurements and/or demand data and/or pricing across all brands featured in a repeatable conversion in the relevant marketplace and (ii) assess the cost or benefit of bidding a quantity of units of a brand of a product or service at the measure previously established for the conversion in the relevant marketplace of the system.

To successfully place one or more sales bids for one or more competitions of a repeatable conversion in a geographic marketplace, a participating merchant manifests its commitment or promise to supply a quantity of units of a product or service within the system's marketplace according to its authorization rules which may require a signature (or its equivalent) of the bidding entity. The merchant may, however, adjust its sales bid or bids at operation 350 for the repeatable conversion at any time beginning with an unveiling by the system of the measure of a product or service featured for a particular marketplace and ending with the system's deadline for altering bids for the particular measure in the repeatable conversion of the relevant geographic marketplace; in some examples the deadline for altering bids occurs simultaneously with the corresponding deadline set for consumer participants and in other examples the merchant deadline occurs after the deadline set for consumers. After any such deadline, the merchant has bound itself to its sales bid (conditioned on the sales preferences submitted in or along with the bid) until the repeatable-conversion concludes, the conclusion marked by a disclosure (i) by the system of any winning bids and related data or analyses to at least the relevant participants, and (ii) that follows a simultaneous processing—of the competition data (including but not limited to bid data, voting data, ratings data, geographic data, etc.) compiled from the various competitions attributed to each brand of a measure of a product or service featured in a repeatable conversion of a particular geographically-defined novel marketplace—for maximum or efficient consumption relative to any or each or all of the competitions in the repeatable conversion. The system in some examples further discloses to participating and eligible merchant-entities the total number of units (per brand featured) of a measure of a product or service authorized for purchase by participating or bidding consumers.

The system also displays the statistics related to the geographical distinctions of the consumer demand for a measure of a product or service featured in a particular geographic marketplace (see operation 340). In some examples the system may disclose for purposes of competitions and matching participants all purchasing preference data collected except for name/identity and individual price-thresholds or -preferences (which may equate to a different term in other embodiments) of any of the participants—whether human or entity—of a repeatable-conversion. A winning merchant's bid of a competition sets the price of consumption for all the consumers having winning bids; a winning consumer-bid in this example comprises (i) a price-preference or -threshold equal to or greater than a winning merchant's price bid and/or (ii) a bid-submission-commitment-time stamp that temporally qualifies or makes eligible the bid for matching with the winning merchant (a temporal stamp on a consumer bid may be ignored or not be required by the system or its administrators for matching a consumer bid with a merchant bid if the winning merchant has offered an infinite or unlimited quantity of a featured brand of the product or service at the price bid by the merchant).

The system also discloses any relevant or applicable conversion or marketplace deadlines (in other examples each conversion for a measure of a product or service in marketplace may contain a running clock to aid in designating the moment or moments in which a participants bid or bids are binding or are no longer subject to change). In other examples, the participating or competing merchants or consumers or participants may encounter two deadlines within a competition (competitions of a conversion in this example can be distinguished between each other by the brand featured; the conversion or repeatable conversion relates to a measure of a product or service featured in a geographic marketplace) of a conversion for a measure of a product or service in a geographic marketplace at least the first of which is binding.

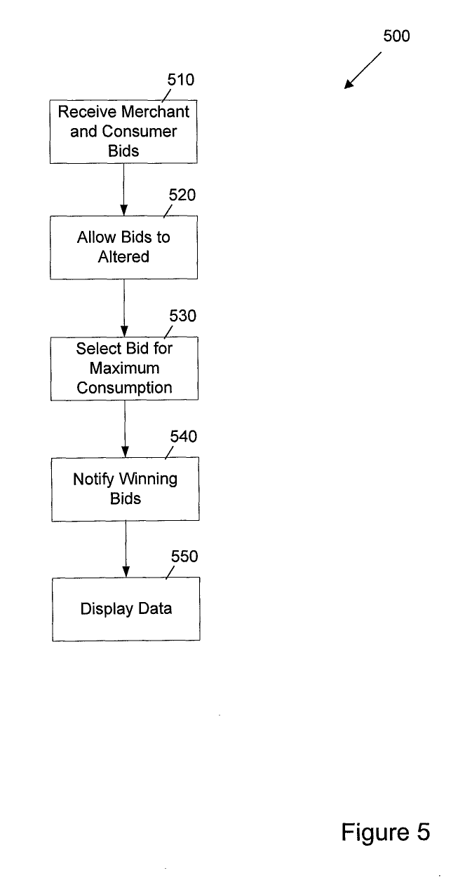

Referring now to FIG. 5, for an example to which to apply this embodiment, one can consider a method 500 for a particular measure of a product or service unveiled or initially featured on a Sunday at 12 pm to begin a repeatable conversion for eligible participants of a relevant geographic marketplace and tier. At operation 510, the consumers have until the following Friday at 12 pm to submit and/or alter their bids before they become binding and final, while the merchants' deadline occurs that Friday at midnight—providing 12 hours extra to consider the demand data disclosed by the system. In other examples of the system, the consumer bids receive a time stamp when (i) submitted to the system as binding, and/or (ii) altered and resubmitted to the system as binding, for the purpose of determining seniority rankings of any or all consumer-bids having a price-preference or -threshold that aligns or matches up or satisfies the sales-price-threshold or -preference of a winning merchant bid; a winning merchant-bid may comprise a finite sales-quantity -threshold or -preference with regards to a number of units of the product or service to supply to winning consumers in the geographic marketplace. At operation 520, the three best-maximum-consumption or most-efficient merchant-bids determined after the initial midnight deadline for each brand featured in the conversion for the measure of the product or service may permit the merchants owning the bids to then use additional time—expiring on Saturday at 12 pm—to improve the efficiency of their bid(s) to compel or incentivize or create greater consumption then their first-deadline bids would have. At operation 530, the merchant bids that create maximum consumption for each featured brand of a previously established measure of a previously established product or service is deemed a winning merchant-entity within that novel-marketplace of the system. At operation 540, the winning merchants and consumers for the measure of the product or service unveiled or initially featured on Sunday at 12 pm then receive electronic receipts from the system during the time between Saturday 12 pm and the following Sunday 12 pm. At operation 550, the system discloses the relevant data related to the matching of winning participant-bids to at least the relevant participants in the aftermath of each repeatable conversion occurring in a geographic marketplace.

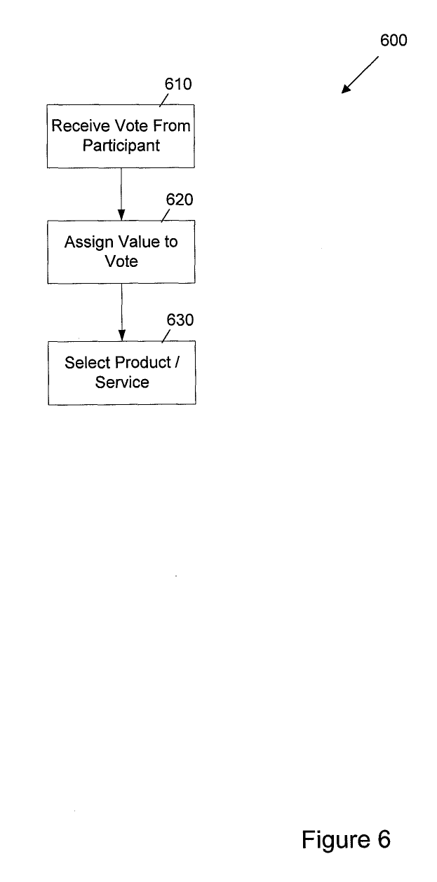

Voting Systems—Referring to an example method 600 shown in FIG. 6, the example system 100 selects the product or service and/or the featured measures and/or brands and/or color (and/or other material or non-material terms of consumption contracts in any industry of commerce comprising but not limited to general retail, insurance, or credit) for a repeatable conversion within a geographically-defined novel marketplace based on the results of a voting system at operation 610. At operation 620, the product-or-service-selection voting system assigns a value to a vote of a consumer or merchant, the value related (i) to the timeliness of the vote's submission to the system and/or (ii) to a participant's voting status determined by previous participation in the geographic marketplace. In some examples of the system, voting in a geographic marketplace in a given tier of the system may close such that only votes received before the closing (occurring upon the passing of a temporal deadline or upon receipt by the system of a particular number of votes established before or during the open-voting timeframe) get processed for points or value based on status and/or time of submission.

A merchant that has a greater level of commitment (a willingness to offer or bid preferences or thresholds to supply products or services at a price lower than offered to individuals consumers in the traditional marketplace) via contract with the system or its administrators than another merchant also has a stronger voting status than the latter for a geographic marketplace or tier (a merchant can have one contract determining its obligations and/or benefits and/or status designations and/or fees (or fee structure) (i) for each marketplace or tier it enters or (ii) for all of the tiers or marketplaces it has eligibility to enter combined in the aggregate) in which the former and latter both have eligibility to participate or compete in. A merchant which provides a winning bid for a repeatable conversion in a geographic marketplace also has a stronger voting status than one which provides a bid that does not actually create maximum consumption. In other examples, a merchant who submits a binding bid (not necessarily a winning binding bid) has a stronger voting status than one which does not.

In this embodiment, maximum consumption is incentivized such that a merchant with a winning bid and the best commitment level has a stronger status than a merchant with a winning bid and a lesser commitment level which has a stronger status than a merchant with the best commitment level and a binding bid submitted which has a greater status than a merchant with a lesser commitment level and a binding bid submitted. In another embodiment commitment is incentivized such that a merchant with a winning bid and the best commitment level has a stronger status than a merchant with a binding bid submitted and the best commitment level which has a stronger status than a merchant with a winning bid and a lesser commitment level which has a stronger status than a merchant with a lesser commitment and a binding bid submitted. In some examples of the system, a merchant's voting status relative to a geographic marketplace or tier results from the its relevant contractual commitment and/or the aggregate results of its competitive or participating transactions in the geographic marketplace.

In alternative embodiments, voting status can affect the determination of a product or service (or its traits or characteristics) featured in repeatable conversion or in one or more of its competitions in a geographic marketplace such that the aggregate vote of the lowest level votes (based on the status of a voter) results in one vote at the next greater level of votes where its aggregate vote results in one vote at the next greater level of votes and so on until the aggregate vote of the greatest level of participation results in one singular vote representing merchants eligible to participate in a repeatable conversion or in one or more of its competitions in the marketplace. In a similar way, the brands and/or measures and/or color and/or other material or non-material term (found typically in consumption contracts of specific industries which comprise but are not limited to general retail, insurance, or credit) related to the product or service featured in the conversion or one or more of its competitions in the geographic marketplace within the system are voted on amongst participating and/or eligible merchants for the marketplace and/or its tier.

The example voting system similarly attributes a value to the voting status of a consumer in a geographic marketplace or tier (determined by his/her previous participation or consumption or contractual commitment in the marketplace or tier). A consumer who has submitted a winning bid has a stronger voting status in the geographic marketplace than one who has merely submitted a binding bid, who has a stronger voting status than one who has only properly registered but has not yet placed a binding bid, who has a stronger voting status than an unregistered visitor to the system.

In this example, voting status can affect the determination of a product or service (or its traits or characteristics) featured in a repeatable conversion or in one of its competitions in a geographic marketplace such that the aggregate vote of the lowest level of votes results in one vote at the next greater level of votes where its aggregate vote results in one vote at the next greater level of votes where ultimately the aggregate vote at the greatest level of votes results in one singular vote representing participating consumers relative to the repeatable conversion or to one or more of its competitions. In a similar way, the brands and/or measures and/or colors and/or other material or non-material terms (found typically in a consumption contract of specific industries which comprise but are not limited to general retail, insurance or credit) related to the product or service featured in the conversion or one or more of its competitions in the geographic marketplace within the system are voted on amongst participating and/or eligible consumers for the marketplace and/or its tier.

At operation 630, the administrators of the system choose between (i) the singular resulting vote of a group of participating and/or eligible merchants for a repeatable conversion or for one or more of its competitions in a geographic marketplace or tier, and (ii) the singular resulting vote of a group of participating and/or eligible consumers for a repeatable conversion or for one or more of its competitions in a geographic marketplace or tier, such that the product or service selected for a week shall be representative of either the consumer-group's voting or the merchant-group's voting. In a similar way, the administrators of the system select the brands and/or measures and/or colors and/or other material or non-material terms (found typically in consumption contract of specific industries which comprise but are not limited to general retail, insurance or credit) related to the product or service featured in the conversion or one or more of its competitions in the geographic marketplace within the system.

Ratings System—In one embodiment, the system 100 also provides participants with a ratings sub-system which provides an opportunity for participants to provide direct feedback to the system in relation to consumption experiences had or relationships formed in connection with a simultaneous processing or matching of bids by the system or its administrators (see Simultaneous-Selection-Outcome Processing/Matching section above) for a repeatable conversion or one or more of its competitions in a geographic marketplace. After a consumer and a merchant are matched for consumption by the system, the consumer may rate within the system his/her overall consumption experience with the merchant such that the consumer's rating factors into a penalty fee portion of the controllable-variable (previously discussed) cost related to the merchant's future or ongoing participation. To guard against the consumer's abuse of the rating sub-system, a merchant may also block itself from being matched with—and consequently rated by—the consumer; in at least one example the merchant must reasonably articulate why it deems the consumer sufficiently risky to block. In another example a merchant must have at least one commercial interaction or encounter with a consumer before it can block him/her from matching with it within the system. A consumer similarly may unilaterally block any or all systematic interactions with a merchant.

In one embodiment, a consumer who has been matched with a merchant in a geographical marketplace may rate the merchant after the matching and/or after his/her receipt of the product or service related to the matching. In this embodiment, the consumer may rate the merchant with either a “plus” or a “minus” such that the merchant accumulates a number of plus-ratings and a number of minus-ratings relative to its participation in one or more of its geographic tiers or marketplaces or in one or more of its repeatable conversions or in one or more of the conversion's competitions.

This example of the ratings subsystem utilizes a fraction created by (i) a denominator that incorporates or implicates any or all or some plus-ratings received by a merchant in the aggregate, and (ii) a numerator that incorporates or implicates any or all or some minus-ratings received by a merchant in the aggregate, to determine a penalty fee for the merchant in a relevant geographic marketplace and/or tier in the system. In this embodiment, a plus sign always factors into the merchant's rating or penalty fee for its benefit (the greater the denominator of a fraction, the smaller the value of the fraction which lower the value of the penalty fee), and a minus-sign factors into the merchant's rating or penalty fee on a condition that a consumer connected to the minus-sign rating also boycotts or blocks any future connection to the merchant within a relevant geographic marketplace and/or within the system. Furthermore a consumer may only give one rating for each of his/her bids systematically matched by the system and/or for each unit of a products or service consumed as a result of a systematic matching with a merchant. If a merchant boycotts or blocks interactions with a consumer in the system or if a consumer boycotts or blocks interactions with a merchant in the system, all the minus-ratings attributed to the merchant by the consumer in a relevant geographic marketplace or tier up to the moment of blocking or boycotting factor into the merchant's rating or penalty fee for the marketplace or tier.

Lottery System—In addition to utilizing equal pricing and simultaneous processing or matching, the system further addresses the inefficient consumption typically experienced by a consumer (or entity) in the traditional marketplace by providing him/her (or it) a lottery sub-system that allows her/him (or it) to win cash (or its equivalent) or other benefits conditioned on his/her (or its) 1) participation eligibility within the system, and 2) lottery status relative to the status of the remaining participants eligible within the system and/or within a relevant geographic tier and/or within a relevant geographic marketplace.

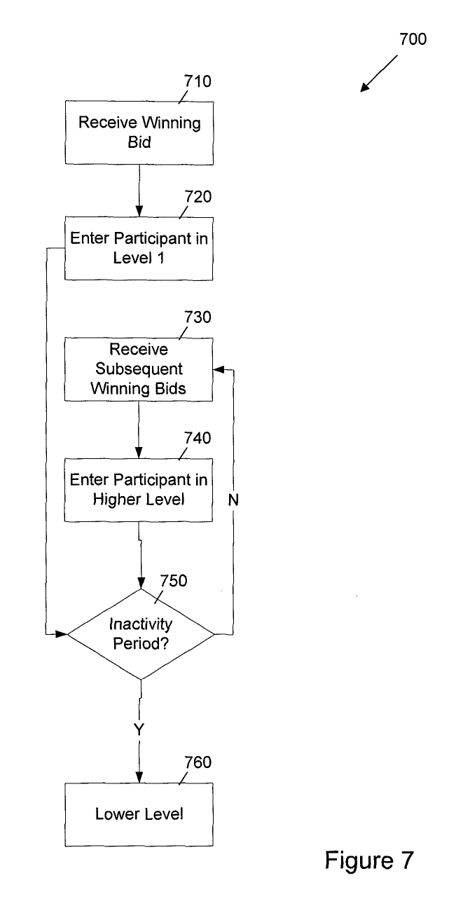

Referring now to a method 700 shown in FIG. 7, a registered consumer becomes eligible to win the lottery after s/he has sufficiently participated (which in one example consists of at least submitting a winning bid) in a geographic marketplace or in one or more repeatable conversions or in one or more of the conversion's competitions in the system (see operation 710). A first winning bid or systematic matching with a merchant (or participant) provides a consumer (or participant) a lottery status consistent with the lowest level of participation (e.g., level one) and meets the first lottery condition at operation 720. A consumer (or participant) may improve his/her (or its) lottery status without limit with each additional winning bid or systematic matching s/he (or it) experiences in the system and/or in a geographic tier and/or in a geographic marketplace such that a second winning bid or systematic matching (see operation 730) provides him/her (or it) a status consistent with the next greater level of participation (e.g. level two) and a third winning bid or systematic matching provides him/her (or it) an even greater status (e.g. level three) and so on and so forth without limit at operation 740. These distinctions in status form a basis for a second lottery condition; both conditions in this example control the payout of benefits by the system and the second condition operates as follows.

Using a number-status as an example or context upon which to apply the payout by the system in this embodiment, the system may generally—subject to conditions—provide cash (or another designated benefit) each day to eligible consumers (or participants) of its lottery sub-system. However, the eligibility of any consumer (or participant) with a status level of 1+x (where x equals any integer greater than zero) to win a lottery's benefit or prize or award becomes temporarily void when any other consumer (or participant) in the relevant geographic marketplace and/or geographic tier and/or in the overall system attains a status level equal to any number greater than zero but less than 1+x ; a first consumer (or participant) at any status level equal to or greater than 1+x become eligible again (i.e. the temporary void is removed from the participant's eligibility to win a lottery) when every relevant consumer (or participant) at a status level lower than 1+x but still equal to or greater than 1 improves to the same status level of the first consumer (or participant). If a consumer at any status level demonstrates sufficient inactivity (in one example such inactivity occurs when a participant engages in no binding and/or consumption-related activity for a prolonged period of at least 3 months) (operation 750), his/her (or its) lottery status will consequently drop to the lowest level (i.e. level zero) and consequently will not factor into the lottery consequences of any or of all or of some of the participants still eligible to receive lottery benefits (operation 760). Otherwise, the consumer's (or participant's) lottery-level status is maintained. In other examples, the system may pay out the benefits of a lottery sub-system on the birthday (or its equivalent) of a consumer (or participant).

A consumer-birthday lottery sub-system in one example of the system allows it or its administrator to select and to award/reward on each day of the calendar year a lottery benefit to an eligible consumer having a birthday on the day of selection or reward; a lottery sub-system may incentivize consumers to participate in the system and may provide a means of counteracting the inefficient spending or consumption typically occurring in the traditional marketplace. In the early stages of the system's commercial existence, it may not have enough eligible consumers with birthdays for each or every calendar day to permit a selection or drawing that would result in a lottery award/reward occurring on an eligible consumer's birthday; under such circumstances, the system may draw or select or award/reward each day a winner for the consumer-birthday lottery from a group of eligible consumers regardless of any actual birthday occurring on the day of the drawing. Lottery-eligibility-status rules discussed previously may still apply.

In a similar way the system or its administrators may use a registration (or incorporation or an equivalent) date assigned by a government (or its agency or by a sovereign entity or its agency) to a merchant-entity—eligible and/or participating in a marketplace or tier in the system—to execute or utilize or implement a lottery sub-system that provides the merchant with benefits, such as free advertising, on its assigned date if the system or its administrators select and/or reward/award the merchant on that date.

In another embodiment, the lotteries and other subsystems function and interact with its participants for 51 weeks out of a calendar year such that the system or its administrators uses the remaining week of the year to reward, based on past participation within the system or its tiers or marketplaces, the best system-competitors—merchants and consumers—with an opportunity to convey an expression related to consumption to the system's users through the system's infrastructure or its public-platform-interface. In other embodiments, the system provides daily such an opportunity of expression to its users. In other embodiments, the system provides such an opportunity daily for eligible users or participants of each geographic marketplace or tier.

Electronic Receipts—After a repeatable conversion has run to completion, winning merchants and consumers will each receive information based on matches created by the processing of competitions in each conversion. A winning consumer will receive information comprising: general shipping rates of the winning merchant relative to various geographic distances from the merchant's shipping address; the consumer's geographic distance from the merchant shipping address; factual disclosures related to a product or service (including but not limited to: brand disclosure, quantity disclosure, price disclosure, basic shipping terms disclosure, warranty policies and/or terms offered or enforced) involved in or stemming from a matching of the merchant with the consumer; and/or advertisements or promotions from 3^{rd} parties such as (but not limited to) warranty-service providers. A winning merchant will receive information comprising: brand disclosure, price-per-unit disclosure, total # of units consumed, transaction fee disclosure, penalty fee disclosure, and/or basic shipping terms disclosure.

In another embodiment, the system provides a communication platform for politicians to reach the system's users. In one example, politicians who lack an affiliation with a major political entity or party may use or access the platform at a relatively low cost to engage the users, while other politicians having an affiliation with a major political party or entity may use or access the platform at a relatively greater cost. This embodiment encourages the communication of political messages, solutions or issues that often lack a platform outside the confines of the system to compete with the platforms of the major political parties or entities supported by the traditional marketplace.

Shipping—The shipping industry benefits from systematic and organized consumption provided by the system, however the merchant often selects the shipping entity to deliver a product or service to a consumer. In this example, the system can require 1) the merchant to pay for return-shipping when the product or service agreed to fails to function or be delivered properly, and 2) the consumer to pay for return-shipping when the product or service is returned for other reasons. The system in one embodiment may provide data related to shipping rates of common carriers for a geographic region corresponding to a geographic marketplace in the system such that a consumer-user may make a knowledgeable comparison of the shipping options available.

In another embodiment, shipping-provider-entities (also known as common carriers) are matched by the system or its administrators with participating or winning consumers in a manner similar to the manner in which the system or its administrators match merchants with consumers for consumption; in one example, a consumer participating in the system may set his/her shipping preferences as a portion of a consumption-bid submitted for matching or processing relative to one or more repeatable conversions and/or to one or more of the conversion's competitions and/or to one or more geographic marketplaces and/or to one or more geographic tiers. In another embodiment, a winning consumer may opt at any time before shipping to pick up a product or service at a merchant's shipping location or address by using the consumption or receipt data related to systematic matching as a reference for the pick-up.

Examples of possible products or services or related industries that are represented in the marketplaces of the system described herein can include (but are not limited to): electronics; gas; restaurant; pharmaceuticals; furniture; fashion/clothing/apparel; rugs/carpets; kitchenware; house ware; acting/theater classes; yoga classes, dance classes, and/or any other types of products or services discussed or disclosed previously.

A hypothetical example of the system's functionality is provided below. Although it describes various embodiments or examples of the system, the following hypothetical is not limiting. The context provided focuses on interactions of hypothetical consumers—“Shopper” and “Friend”—and merchants—“Big Store (‘BS’)” and “Small Store (‘SS’)”—with the system and also uses arbitrary or hypothetical numbers, letters, products, services, brands, types, dates, months, days, geographies, etc.

In early January Shopper, who resides in MN and has a birthday in February, receives a phone call from Friend, who resides in MI. Friend discusses MI's various social and political problems affecting it and its cities like Detroit. Detroit's main problem according to Friend stems from the businesses and government in Detroit and MI having no money. The residents of MI also have little, if any, money. Shopper has money for necessities but not for charities or philanthropic causes. Friend asks Shopper to use the system to purchase his necessities while simultaneously helping MI and Detroit by purchasing from businesses there. Shopper accepts the request and decides to purchase the goods and services he needs using the system. Shopper needs gasoline for his car.

Shopper visits the system on the same day in January and selects a geographic tier labeled “States” which causes a list of states to populate the computer screen in front of him. Shopper then selects a marketplace labeled “MI” to ensure that his purchase during this visit will acquire him a good or service from a business based in MI. Thereafter, Shopper's screen presents a page for the MI marketplace with a list of products or services—organized by chronological availability—for purchase and time periods next to each good or service listed. He sees a product labeled “Gasoline For Autos” which correlates to a week during the previous December. Though selecting the product would cause the presentation of statistics stemming from purchases during the December week, Shopper decides that he prefers to actually purchase gasoline and thus uses instruments provided to reorganize the list of products or services. Shopper sees a query instrument that resembles a search engine and types in the query terms “gasoline gas or fuel” into the instrument. The search populates a list of three products (labeled with at least one of the terms used) with time periods next to each product label: “Premium Gas (March-Week 1),” “Super Gasoline (May week 3)” and “Regular Gas (February Week 2)”.

He selects “Regular Gas,” which has a week in February listed along with the label. Selecting “Regular Gas” causes the system to populate a page designated for the Monday of the week; other days of the same week populate a side bar on the screen for Shopper's selection. The MI marketplace page provides Shopper with an opportunity on the Monday to purchase 10 gallons of gas; Shopper prefers to buy in greater bulk and sees from the side bar an opportunity to purchase 100 gallons on the Thursday of the same week. Shopper selects Thursday's page which presents him with four brands of gas for which he may place purchasing preferences.

Each brand has related factual information such as the number of units of the 500 gallon measure already authorized for purchase. Shopper also sees data showing an average price per gallon (“price/gallon”) for each brand in MI. In MI's traditional marketplace, Brand A has an average price/gallon of $3; Brand B has one of $4; Brand C has one of $5; and Brand D has one of $6. Shopper has no preference for any of the brands featured, so after being presented with two options by the system with which to designate himself, Shopper selects “brand indifferent” rather than “brand preferential.” If Shopper didn't want to purchase one or more of the brands featured, Shopper would have selected “brand preferential” and subsequently placed price thresholds for only the brands he preferred. Shopper, however, has indifference, and the system thus requires him to place price thresholds for each (because he's indifferent) of the four brands in order to place a bid.

Shopper also enters a quantity of units per brand (“quantity/brand”) he prefers and an overall quantity (“total quantity”) across all the featured brands he prefers. Shopper inputs the following purchasing preferences: Brand A [$200, 2 units]; Brand B [$300, 1 unit]; Brand C [$300, 3 units]; Brand D [$400, 2 units]; total quantity=3 units. On these preferences, Shopper has authorized at most a purchase for 3 units of 100 gallons of gas (possible total consumption=300 gallons) at a maximum price threshold of $1100 (2 units of Brand D+1 unit of Brand C, for example).

Shopper attempts to submit his preferences to the system, but the system prompts him to register with the system so he can authorize the purchasing preferences he had designated for Brands A, B, C & D. Shopper registers his information with the system and subsequently authorizes his preferential purchases using his credit card to make a hold-charge payment of $1100. Shopper next receives for his personal records an electronic confirmation of the authorization that also notes the time/date of authorization to compete for each brand. He notes a timer (showing days, hours, minutes, and seconds) in proximity to the four brands featured that counts down to the deadline for modifications or authorizations; the deadline for the 100 gallon opportunity occurs on the Tuesday following the Thursday of week 2 in February.

On the same day in January, Friend visits the same MI marketplace and the same repeatable conversion for 100 gallons of gas also marked as Thursday-week 2 of February. Friend authorizes a purchasing preference of 1 unit only of Brand A (Friend is “brand preferential”) at $300. His preferred total quantity amounts to 1 unit and his authorized hold-charge payment amounts to $300. Friend receives a confirmation of the authorized hold-charge that also notes the time/date of the authorization to compete for Brand A.

In late January Shopper decides to modify his purchasing preferences; he modifies his preferences for Brand A from [$200, 2 units] to [$250, 1 unit]. He authorizes the modification, and the system provides him electronic confirmation of the modification with the time/date of the latest authorization. He notes that his preferences for Brands B, C & D still have the earlier authorization time/date from early January while his preferences for Brand A have the later authorization time/date. Shopper may modify his preferences for Brands A, B, C or D at any time beyond the Thursday in week 2 of February until the 100-gallon-repeatable-conversion deadline: Tuesday of week 3 in February. Shopper does not use the system again until after that Tuesday in February.

Big Store has 1000 employees, 300 of whom work and live in MI and 900 of whom work in other Midwest states. The geographic tier labeled “States” seems to suit Big Store's needs so in January it selects the tier and subsequently selects the “MI” marketplace. The system prompts Big Store to register itself before gaining access to any marketplace in the system. After registering the required information, Big Store realizes the system will not permit access to the MI marketplace because Big Store has too many employees paying taxes outside of MI. Big Store thus ultimately opts to sell through a geographic tier labeled “Nation” in the system. Big Store may expect to find big merchants placing sale bids throughout the marketplaces of this tier.

Small Store has 100 employees all of whom work and live in MI. Small store visits the system in January and selects the “States” tier, the “MI” marketplace, the “Regular Gas (February Week 2)” product, and the “100-gallon (Thursday)” repeatable conversion for the MI marketplace. Small Store carries Brands A, B, C & D and inputs the following sales thresholds: Brand A [$220, 100 units]; Brand B [$200, 1000 units]; Brand C [$250, 1000 units]; Brand D [$300, 500 units]. Small Store, before inputting its sales preferences, noted from the data disclosed by the system that some of the demand for Brands A, B, C & D originated outside the state of MI in states including but not limited to MN (remember Shopper resides in MN).

The system prohibits submission of any sales or purchasing preferences in the “MI” marketplace for the 100-gallon-gas repeatable conversion after the Tuesday of week 3 of February. On the Tuesday at 9 am, the system blocks consumers from modifying or authorizing purchase preferences; on Tuesday at 9 pm, the system blocks sellers from modifying or authorizing sales preferences. After 9 pm, the system processes the preference data to match consumers with sellers to create maximum consumption from the 100-gallon-gas repeatable conversion data received. By Thursday of week 3 of February, the system discloses results of the processing for maximum consumption which follow:

(i) Small Store receives: $22,000 in exchange for supplying 100 units of 100 gallons of gas of Brand A to winning consumers including Friend but not Shopper; $100,000 in exchange for supplying 500 units of 100 gallons of gas of Brand B to winning consumers including Shopper but not Friend; $150,000 in exchange for supplying 500 units of 100 gallons of gas of Brand D to winning consumers including Shopper but not Friend (another store won the competition to supply units of Brand C).

(ii) Shopper: bid $300 for 1 unit of 100 gallons of gas of Brand B and received 1 unit for $200 ($2=price/gallon; compare average price/gallon of $4 in the traditional marketplace in MI); bid $400 for each of a maximum 2 units of 100 gallons of gas of Brand D and received 2 units for $300 per unit ($3=price/gallon; compare average price/gallon of $6 in the traditional marketplace in MI); bid $250 for 1 unit of 100 gallons of gas of Brand A but did not receive any units of Brand A (Small Store supplied Brand A for $220 per unit but had a threshold quantity of 100 units; Shopper's Brand A purchasing-preference submission met the pricing requirement of Small Store but related to the 101st unit authorized—based on the late January modification by Shopper—thus placing Shopper's submission for Brand A outside Small Store's quantity threshold). Shopper authorized a hold-charge payment of $1100 but only spent $800 total. Shopper has consummated transactions within the system for 3 units of 100 gallons of gas total. Shopper's information will be submitted to the system's lottery on his birthday in February.

(iii) Friend: bid $300 for 1 unit of 100 gallons of gas of Brand A and received 1 unit for $220 ($2.20=price/gallon; compare average price/gallon of $3 in the traditional marketplace in MI); bid on no other brand competitions in the 100-gallon repeatable conversion.

Shopper and Friend receive electronic receipts detailing the consummated transactions. Friend plans to pick up his gas cards from Small Store the week after receiving his receipt and offers to pick up Shopper's card for him. Shopper has been having problems receiving mail and thus decides to accept Friend's pick-up offer because Shopper and Friend will be visiting with one another soon anyway. Shopper provides Friend's information from his electronic receipt and thereafter cancels the shipping order Small Store would have otherwise executed for Shopper's transaction. Shopper no longer has to pay for the shipping of his gas cards—each having credit for 100 gallons of gas at Small Store retail locations.

Friend knows that some stores using the system charge for shipping while others do not. Friend explains this reality to Shopper. Shopper learns from Friend that Shopper can rate within the system his experience with Small Store for each unit (gas card) of 100 gallons he purchased. Had Shopper had to pay shipping, he knows he would have rated Small Store differently than he ultimately did. Furthermore, Shopper's electronic receipt acts as proof of purchase should Small Store not deliver on its obligations related to the consummated transaction with Shopper. Small Store did not have to compete against Big Store for Shopper's and Friend's business. Small Store has received $272,000 in revenue before providing gas to consumers via the system and before paying transaction or penalty fees to the system. Small Store in MI has formed through the system a relationship with Shopper in MN.

The example systems and methods described herein can be implemented in a computing environment 101 on one or more computing devices. For example, the system 100 can be one or more computing devices accessible through the network 130. The consumers 110 and the merchants 120 can interact with the system 100 using computing devices running an application, such as a browser or custom application. Computing devices can include laptops, desktops, tablets, mobile devices like cellular telephones, etc.

An example computer device includes input devices, output devices, a processor, and physical memory. The memory includes computer-executable instructions which, when executed by the processor, cause the processor to perform one or more of the systems and methods described herein.

One or more advantages can be associated with the systems and methods described herein. For example, one advantage of the examples disclosed herein is that the examples provide competitive arrangements in order to capture consumer demand independently of the supply of any individual merchant entities while simultaneously or contemporaneously or concurrently capturing one or more merchant-entities' supply independently of the demand information of any individual consumer. Some of the examples provide for simultaneously matching groups of consumers with individual merchants using maximum consumption principles rather than simple price-point bidding or auctioning for the purpose of creating new “relationships” between merchants and consumers within which each party thereafter may rate and/or even boycott the other.

The present disclosure provides efficiency by systematically selecting products and/or services for consumption based on the voting of consumers and entities participating such that any individual consumer or individual entity has a voting power based at least on previous participation within the network system of novel marketplaces and sometimes on the timeliness of the actual voting.

In one embodiment, the present disclosure provides different levels of marketplaces; one example of various levels would be global, national, state, county, city. In this particular embodiment, the present disclosure prohibits any merchant entity from entering more than one marketplace within a given level of marketplace; a consumer in contrast may enter any marketplace within any marketplace level.

In one embodiment, the consumer, assuming successful completion of standard registration requirements known in the industry, selects a geographical market after which s/he selects a product or service category (or product or service) corresponding to a given week in a given year in the geographical market. In this embodiment, each day of the selected week corresponds to different measure of the product or service. In this embodiment, the product category (or product or service) is determined by systematic voting such that a participant's voting power is based on the previous participation of it/him/her and/or on the timeliness of the submission of a vote; in the aggregate, human consumers who vote consequently offer up one product or service category (or product or service) while merchant entities in the aggregate offer up another via voting such that the system provider chooses either the selection of the merchant group or the consumer group without ever introducing its own selection. The marketplace thus dictates the products or services consumed within the system.

In this embodiment, after a consumer has chosen a marketplace and a corresponding measure of the product or service, s/he may then designate the price, brand and quantity s/he can afford using a closed-bid mechanism; the individual consumer in this embodiment provides credit card authorization in the form of a hold-charge for his/her designated purchase preferences to create consumer demand supported by revenue or funds that merchants may try to capture. The price, brand and quantity an individual consumer designates in a closed bid may be marked for time-of-submission by the system provider for matching consumers with a merchant that has a finite supply of product or service. In this embodiment, the merchant entity participating may use limited consumer demand data that does not include individual consumers' “price point” preferences disclosed by the system provider to bid a price point, quantity and brand in order to create maximum consumption and equal pricing while capturing volume sales from the consumer demand aggregated independently; the participating merchant entity is provided via disclosure the maximum number of units authorized for purchase by consumers in a geographic marketplace. A merchant entity matched to a group of consumers by the system provider must deliver products or services at the price-point bid and at the quantity bid; a merchant entity may state a quantity preference valued at infinity or unlimited if it so chooses.

In this embodiment, an individual consumer may input purchasing preferences that match him or her with multiple merchants of different brands for the same measure of the same product/service category; an individual consumer may consume different brands from the same merchant for a given measure of the same product/service category. In this embodiment, only merchants that capture volume sales using the system pay a percentage of the total revenue generated as a transaction and/or penalty fee to the system provider; the interest for a winning merchant entity is based on that merchant's participation, commitment level and/or quality of business (based on systematic ratings) conducted with consumers within the example system disclosed herein, however merchant entities may boycott individual consumers just as individual consumers may also boycott individual merchant entities. In this embodiment, the system may also display consumption-data results to the winning participants.

In other embodiments, merchant or consumer users may interact with each subsystem prior to or after registration with limitations of access and/or participation corresponding to the users' statuses.

In yet another example, a user may search for a product or service using search engine technology that searches among the marketplace(s) within the system. A search may be conducted by (but not limited to) one or more of the following query subjects: time, geography, tier, stage of voting, merchant, product, service, measure, industry, etc. Searching can also be done within the system by means of a directory (e.g., hierarchical) or a directional structure. Other embodiments are possible.

What is claimed is:

1. A method for facilitating a sale of a good or a service, the method comprising:
receiving a selection of a geographic tier, the geographic tier defining a particular geography in which a seller is located;
receiving a time period;
receiving a bid from the seller for the sale of the good or the service within the time period;
matching the bid with consumers whose offers meet requirements of the bid from the seller;
when the bid results in maximum consumption of the good or the service:
selecting the bid; and
transferring money from the consumers to the seller.

2. The method of claim 1, further comprising receiving registration information from the seller.

3. The method of claim 1, wherein receiving the selection of the geographic tier includes allowing the seller to select from one of the following: nation, state, county, and city.

4. The method of claim 3, further comprising allowing the seller to select only those geographic tiers in which the seller is located.

5. The method of claim 3, further comprising providing demographics to the seller regarding the geographic tier.

6. The method of claim 1, further comprising allowing the seller to modify the bid.

7. The method of claim 1, further comprising receiving a vote from the seller for the good or the service to be offered for the geographic tier.

8. A method for facilitating a sale of a good or a service, the method comprising:
receiving a selection of a geographic tier, the geographic tier defining a particular geography in which a consumer is located;
receiving a particular time period;
receiving an offer including a price threshold for the good or the service;
matching the offer to one or more bids to provide the good or the service; and
when the offer meets requirements of a winning bid, notifying the consumer of a consummated transaction.

9. The method of claim 8, further comprising receiving a vote from the consumer for the good or the service to be offered for the geographic tier.

10. The method of claim 9, further comprising assigning a value to the vote based on past interactions with the consumer.

11. The method of claim 10, further comprising selecting the good or the service based on the vote.

12. The method of claim 10, further comprising:
receiving a first winning offer from the consumer;
placing the consumer in a first lottery level;
receiving second winning offer from the consumer;
placing the consumer in a second lottery level; and
awarding an incentive based on a level status of the consumer.

13. The method of claim 12, wherein awarding the incentive includes selecting the consumer based on the level status and another criteria associated with the consumer.

14. The method of claim 8, further comprising receiving branding requirements from the consumer for the good or the service.

15. The method of claim 8, further comprising allowing the consumer to modify the offer.

16. The method of claim 8, further comprising receiving registration information from the consumer.

17. The method of claim 8, wherein receiving the selection of the geographic tier includes allowing the consumer to select from one of the following: nation, state, county, and city.

18. A method for facilitating a sale of a good or a service, the method comprising:
receiving a selection from a consumer of a geographic tier from a group including nation, state, county, and city;
receiving a vote from the consumer for the good or the service to be offered for the geographic tier;
receiving a particular time period;
receiving branding requirements from the consumer for the good or the service;
receiving an offer including a price threshold for the good or the service;
matching the offer to one or more bids to provide the good or the service; and
when the offer meets requirements of a winning bid, notifying the consumer of a consummated transaction.

19. The method of claim 18, further comprising assigning a value to the vote based on past interactions with the consumer.

20. The method of claim 18, further comprising:
receiving a first winning offer from the consumer;
placing the consumer in a first lottery level;
receiving second winning offer from the consumer;
placing the consumer in a second lottery level; and
awarding an incentive based on a level status of the consumer.
